(19) United States
(12) Patent Application Publication
(10) Pub. No.: US 2002/0057269 A1
(43) Pub. Date: May 16, 2002

(54) Method and apparatus for identifying the selection and exclusion of elements of complex sets

(76) Inventors: Glenn A. Barber, Irvine, CA (US); Lorin E. Brennan, Balboa Island, CA (US)

Correspondence Address: Kenneth W. Float, The Law Offices of Kenneth W. Float, P.O. Box 80790, Rancho Santa Margarita, CA, 92688, US

(21) Appl. No.: 10/008,260

(22) Filed: Oct. 26, 2001

Related U.S. Application Data
(60) Provisional application No. 60/249,061, filed on Nov. 15, 2000.

(51) Int. Cl. G06T 1/00

(52) U.S. Cl. 345/418

(57) ABSTRACT

A process embodied in apparatus, methods, or software, which, given an identified set and its constituent subsets, identifies which subsets, and their constituent subsets, have been selected or excluded from the given set and the manner of such selection or exclusion. Using a preferred embodiment of the invention in software on a computer system with a graphical display, the process may he used to represent graphically in a “treelike” presentation the entire set of elements along with the identification of the elements selected from the set and the manner in which elements were selected or excluded to arrive at the net selection result.

### BACKGROUND

The present invention relates generally to computerized information systems directed to commercial applications, and more particularly, to methods and apparatus that facilitate, through use of software programs identifying the selection or exclusion and manner of selection or exclusion of complex sets of objects drawn from other sets of such objects.

A difficult problem in business processes involves selecting sets of elements contained in larger sets. Abstractly, a set of elements can often be partitioned into disjoint subsets, each of which can themselves be partitioned into disjoint subsets and so on down to their atomic elements. Such a partition can then be represented in a hierarchical “tree” structure with the main set represented as the “root”, subsets represented as “branches”, and atomic elements as “leaves”. From a set represented in such a partitioning, it may be desirable to select a discrete subset consisting of various partitioning subsets (“branches”) that themselves contain or exclude branches or leaves.

In one embodiment, this hierarchical partitioning can be represented graphically in a treelike presentation in which result of the process of selecting or excluding “branches” or “leaves” can be represented by the designation of items. The problem comes in designing an efficient process to implement both the means and manner of selection and exclusion as these data partitions become more detailed and the selections become more complex.

An illustrative example is the problem of graphical selection and identification of world territories to which a certain exhibition right may be granted to a licensee. Such exhibition rights may be granted to widely defined geographical regions with exclusions designated at a common language area or country scope within the region, or the grants may name specific combinations of common language areas and countries. In such a case the manner of the selection may have legal import and may need to preserve the original legal language of the grant. This example is illustrated in more detail below when discussing an illustrative implementation of the present invention.

It is therefore an objective of the present invention to provide for improved processes that facilitate, through use of software programs, identifying the selection or exclusion and the manner of selection or exclusion of complex sets of objects drawn from other sets of such objects.

### SUMMARY OF THE INVENTION

To accomplish the above and other objectives, the present invention provides for methods and apparatus that select or exclude and identify the manner of selecting and excluding complex sets of objects contained in a set of such objects. The methods and apparatus also illustrate object selection and exclusion in a tree-like graphical form.

Exemplary apparatus comprises an input data memory, a processing system. including software, and an output data device. The input data memory stores a mapping from objects in a set of objects from which a complex set is to be selected to a set of nodes organized in a tree-like structure that represents a hierarchical ordering of such objects. The input data memory stores an identification of each node independent of its position in the hierarchy, and identifies each node in relation to other nodes in the hierarchy. This identification is achieved by storing references, if any, to a parent node, one or more sibling nodes and one or more child nodes, along with an indication of whether the representation constitutes a full or partial partition of the set that is represented. The input data memory also stores a status state of the selection or exclusion of each node and a related system of graphical icons to represent the status state of selection or exclusion of the node.

The processing system and software are operative to change the status state of nodes in a tree-like graphical presentation of the nodes, store the results in the data memory, and change the graphical icon representation of such states based on an input event from the user. To achieve this, the software processes the data in the following manner.

The software evaluates a current state of selection or exclusion of a node that is subject to an event, and, based on such state, retains or changes the state in a designated sequence based upon receipt of the input event, and updates a display of the graphical icon representing the state resulting from such processing that corresponds to the node.

The software recursively evaluates the current state of selection or exclusion of each child node, if any, of the node that is subject to the event, and, based on the state of selection, retains or changes the state in a designated sequence based upon the result of the processing of the node subject to the input event and updates the display of the graphical icon representing the state resulting from such processing that corresponds to the child node.

The software recursively evaluates the current state of selection or exclusion of each parent node, if any, of the node subject to the event, and determines whether all child nodes of the parent constitute a complete partition of the object represented by the parent node, and based on the results, retains or changes the status state of the icon in a designated sequence and updating the display of the graphical icon representing the state resulting from such processing that corresponds to the parent node.

The output data device updates the status state of selection of each node effected by the input event by operation of the process and stores the change in data memory, which changes the icon graphically representing the status of selection or exclusion of each node so affected.

### BRIEF DESCRIPTION OF THE DRAWINGS

The various features and advantages of the present invention may be more readily understood with reference to the following detailed description taken in conjunction with the accompanying drawings, wherein like reference numerals designate like structural element, and in which:

FIG. 1 is a block diagram of a node architecture used to illustrate the terminology and concepts used in describing the present invention;

FIG. 2 is a block diagram of node object relationship illustrating how the node structure can be related to external objects;

FIG. 3 is a table listing the different status states that a node can assume in the invention, along with a set of graphical icons representing the state and an explanation of their meaning;

FIGS. 4A-4C are flow charts illustrating an exemplary embodiment of the present invention showing the process that occurs upon selecting a node, including a process for determining the current status of the node, updating that status based on the selection, and reflecting the effect on any child or parent nodes;

FIGS. 5A and 5B are flow charts showing a process that occurs for updating the status of a child node depending on the selection of a parent node;

FIGS. 6A-6G are flow charts showing the process for updating the status of a parent node depending on the selection of a child node;

FIG. 7 is a flow chart showing a process for counting the child nodes of a parent node as a step in utilizing the process in the previous flow charts;

FIG. 8 illustrates an exemplary “Territory Tree” displayed using the present invention;

FIG. 9 illustrates an exemplary “Expanded Territory Tree” displayed using the present invention;

FIG. 10 illustrates an exemplary “Sample Selection” displayed using the present invention;

FIG. 11 illustrates an exemplary “Selection with Exclusions” displayed using the present invention;

FIG. 12 illustrates an “Alternate Example of Selection with Exclusions” displayed using the present invention; and

FIG. 13 illustrates an exemplary “Complex Set with Inclusions and Exclusions” displayed using the present invention.

### DETAILED DESCRIPTION

The following discussion describes the design, structure and operation of the present invention. Reference to the drawing figures will facilitate a better understanding how the present invention operates.

### a. Description of Tree and Nodes

Preliminarily, certain terms are described to establish clarity of presentation of the concepts of the present invention. A tree is defined as a graphical presentation displaying the hierarchical containment organization of a set of related objects along with the selection status of each object of the hierarchy. Following standard practice [e.g. Rajjan Shinghal, FORMAL CONCEPTS IN ARTIFICIAL INTELLIGENCE. p. 391-392 [Chapman & Hall 1992], the tree may be treated as a directed graph comprised of arcs and nodes. A node is a position holder for an object and represents the placement of the object in a hierarchically ordered set of objects. When a node is wholly contained within a set defined by another node, it is said to be a child node. A node containing a child node is its parent node. An arc designates this parent-child relationship between nodes: pointing from the child to its parent or from the parent to a child. A source node is the single node that has no parent. Two child nodes that share a common parent node are called siblings. The source node may be called a “root” of a tree, individual nodes may be called “branches”, and a node with no children may be called a “leaf”. This alternative terminology may sometimes be used in the discussion below.

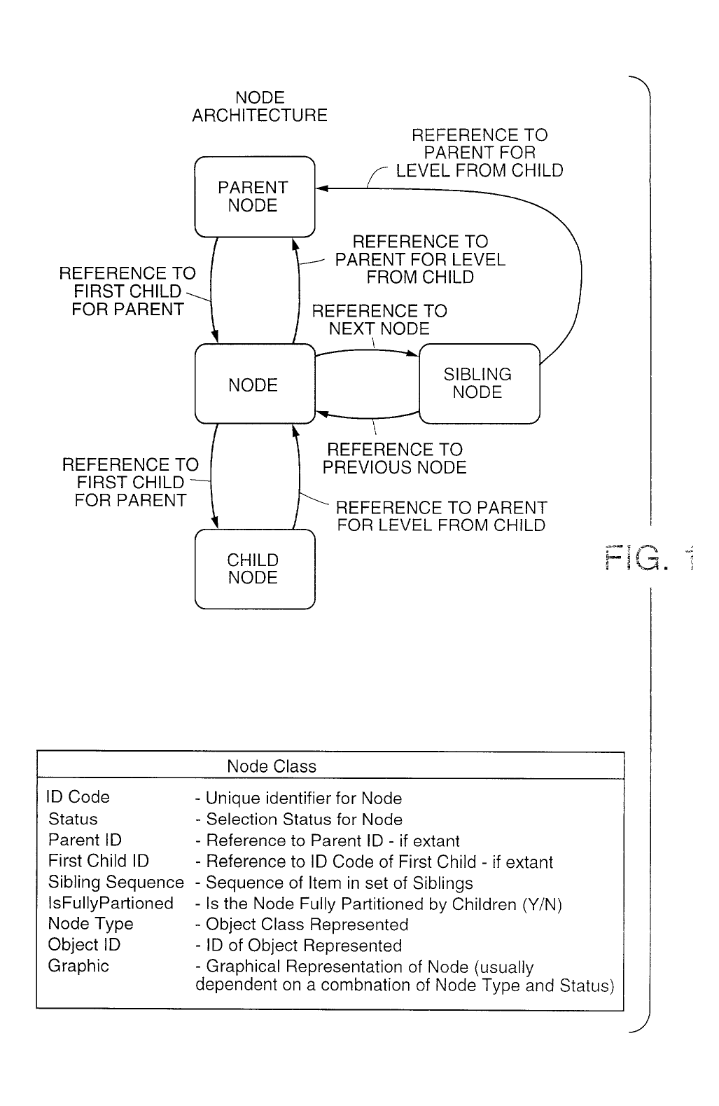

FIG. 1 contains an abstract illustration of node architecture illustrating the above-discussed concepts. This architecture is included as a prelude to illustrating the concepts involved in implementing the present invention. A child node is by custom is represented as “lower” down on a tree and a “parent node” is customarily represented as represented as “higher” up on the tree. Sibling nodes are customarily presented together at the same level of the tree.

A parent node may have multiple children. Where the tree represents a disjoint partitioning of a set, a node has a single parent, although that parent may be the child of another parent. Where the tree represents an ordered data structure, a tree in which any child has a single parent is called a hierarchical structure; where a child node can have multiple (or no) parents, the data structure is called a network. [See C. J. Date, AN INTRODUCTION TO DATABASE SYSTEMS, App. B (Hierarchical System). App. C (Network System) (5th ed. 1991, Addison Wesley]. The present invention may be implemented with hierarchical structures. The process of “walking the tree” involves starting at the root node (or other initial node) and following each arc through child nodes and past sibling nodes until the desired node is reached.

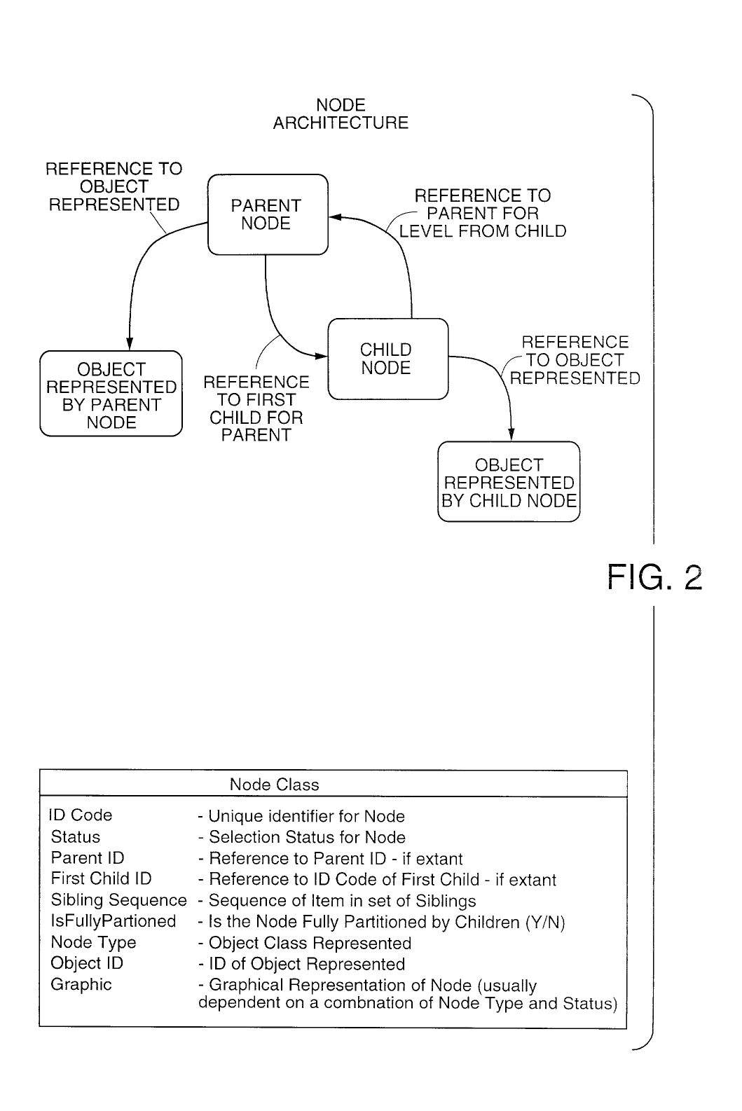

FIG. 2 illustrates how the present invention may be coupled to an external representation to achieve these results. Each node is given an ID Code that uniquely identifies the node independent of its order in the tree. The order between nodes is determined by references (abstractly, arc identifiers) that designate the connection to other nodes. The references are Parent ID, which refers to the ID Code for the parent node of the node; First Child ID, which references the ID Code of the first child of the node (null if no child); and Sibling Order Sequence that refers to the ordering of siblings. The node then has a reference to an external object that designates what the node represents in another structure. The object can be a data primitive, and entire data structure, or another entity with its own internal structure.

It is important to understand that the tree represents the objects but is not the objects themselves. What the present invention facilitates is a process for selecting sets of objects by the graphical representation in the tree. In general, one maps the objects to nodes in the tree. One then uses the present invention to select complex sets of the objects represented in the tree. One can then utilize the mapping to derive the result set derived from the original set of objects as a result of the operation of the selection process.

### b. Description of Node Attributes

In order to facilitate the process of selection, the present invention provides a process for designating how nodes are selected or excluded by assigning to each node an attribute list. This attribute list designates certain aspects of a node's Current state and manner of selection. The following attributes are assigned to each node in a tree:

ID. Code: A unique identifier code for the node: allows processing by reference to the node independent of position.

Status: Designates the manner of selection or exclusion of the node; eight different states are possible, as discussed below.

Parent ID: References the ID code for a parent node. If the node is the root node, this value is null.

First Child ID: References the ID code for the first child node of the node. If there are no child nodes, i.e. the node is a “leaf” or terminal node, this value is null.

Sibling Order Sequence: The order sequence for this node in relation to its siblings.

IsFullyPartitioned: This identifies the condition as to whether or not the object represented by this node equates to the union of all of its direct child nodes.

Node Type: Where the node is used to represent an external object, this is a reference to the object class represented. It indicates the class of object represented.

Object ID: Where the node is used to represent an external object, this is a reference to the specific object represented within the class type.

Selection Graphic: In the preferred implementation, an associated graphic icon symbol illustrating the selection status.

Object Graphic In a preferred implementation, an associated graphic icon symbol illustrating the object represented by the node.

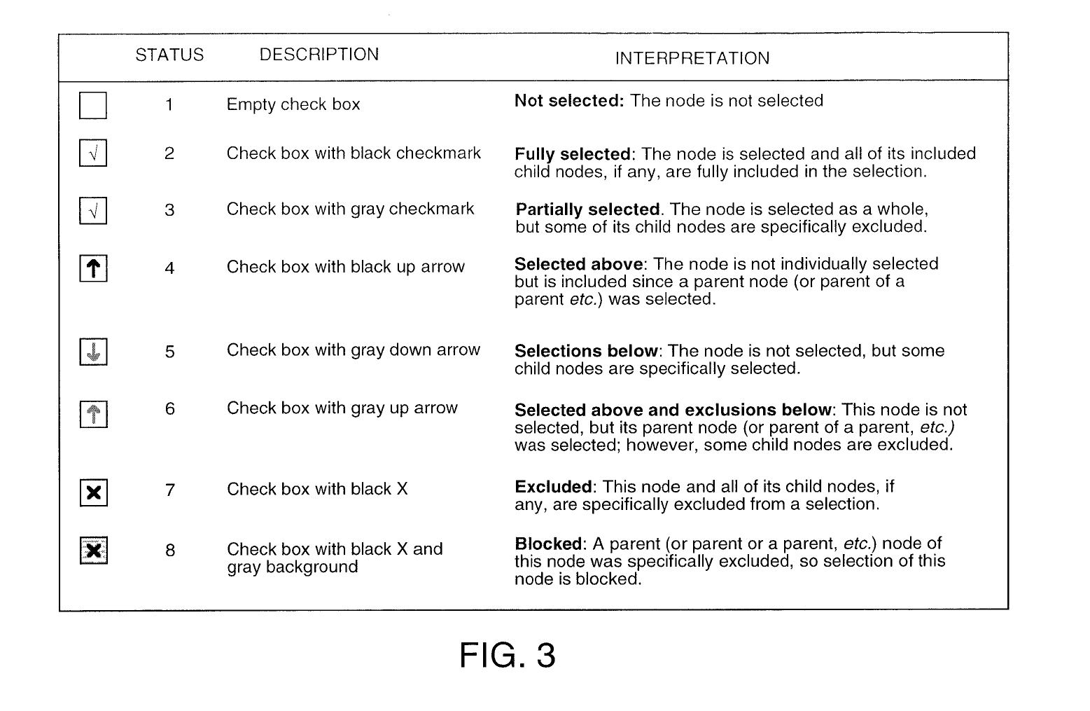

In the preferred implementation of the present invention, a series of graphic icons are associated with each node to designate the node status. FIG. 3 illustrates these status icons. This set of icons is a preferred aspect of the present invention. For convenience of reference in the discussion that follows, a number is used to designate each status, although other designations may be employed if sufficient to constitute a unique reference.

### c. Selection Process

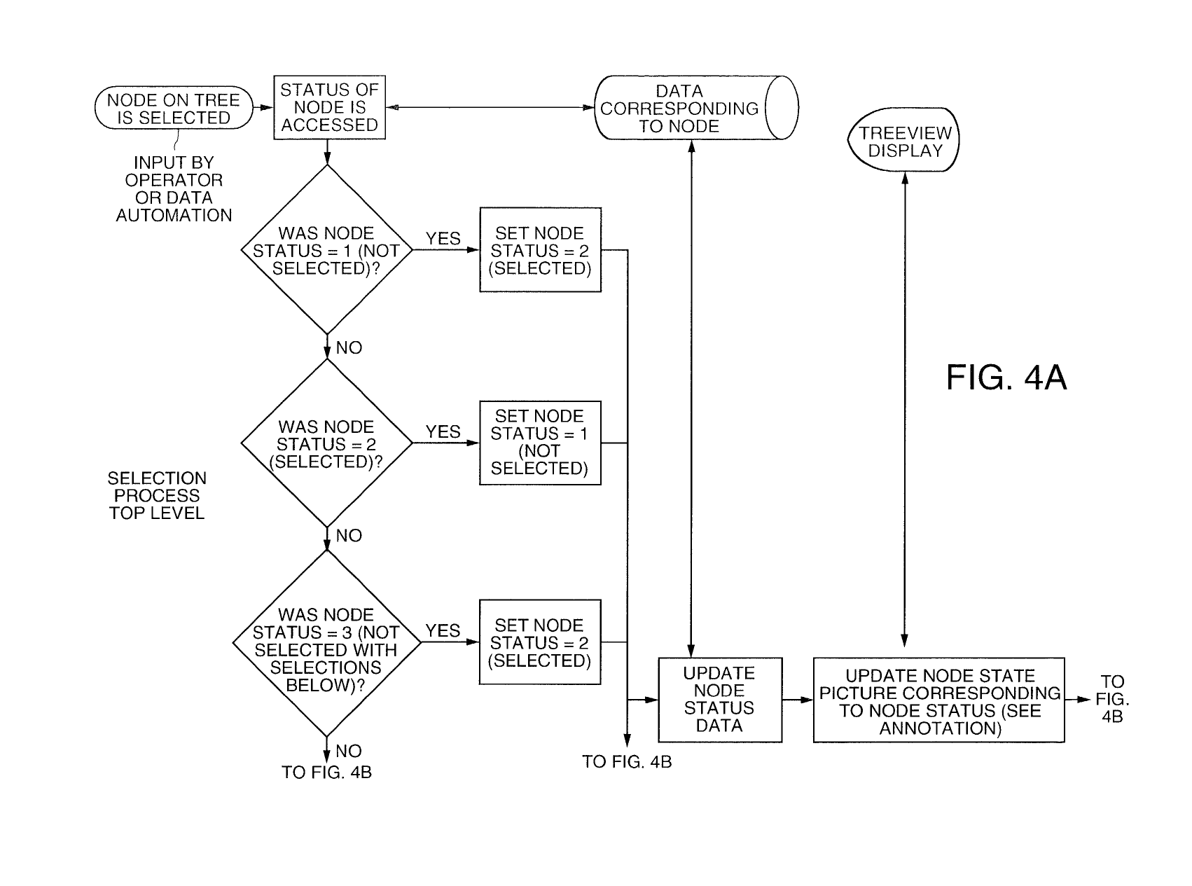

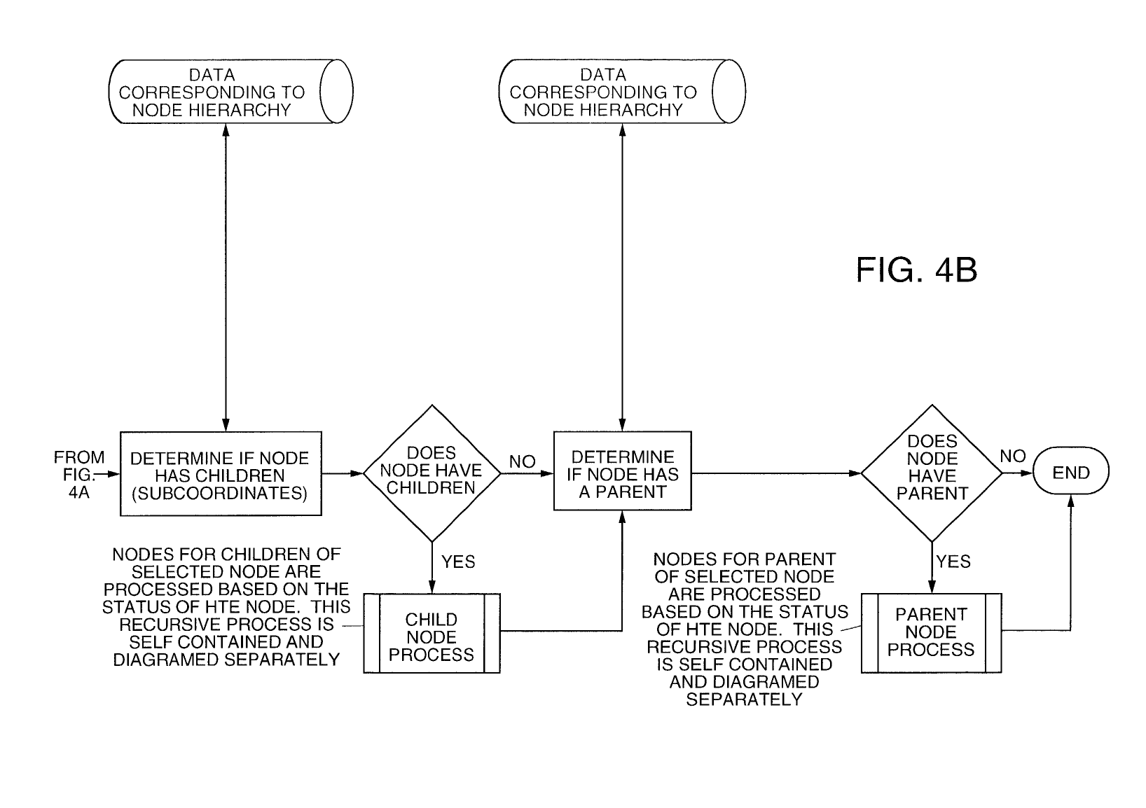

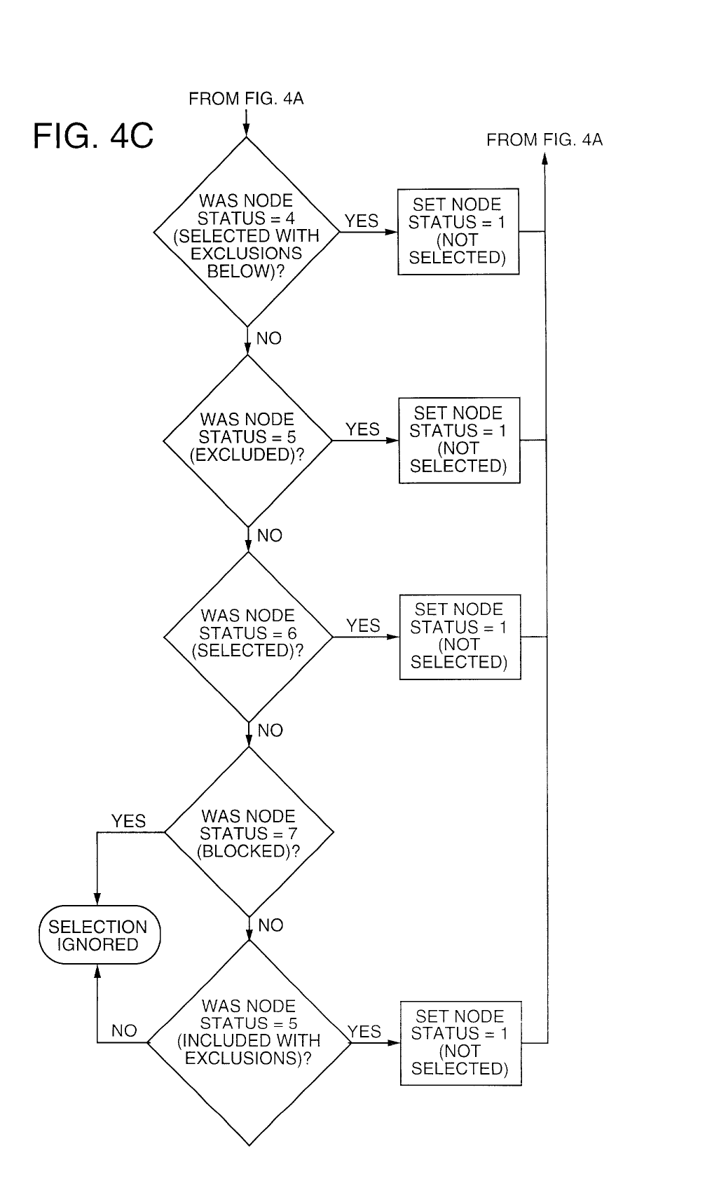

FIGS. 4A and 4B, entitled “Selection Process”, illustrate the process utilized in the present invention when a node on a tree is selected. FIGS. 4A and 4B are best reviewed side-by-side when connected at the “A” connection symbols. The process operates as follows.

The process begins with the action designated in the upper left hand corner of FIG. 4A. Input by an operator or data automation causes the node to be selected. The process first determines the current state of the node. By default, all nodes are originally set to “unselected”. However, if the node was previously selected or excluded, accessing its current status is necessary in case this action will alter a previous state.

The next process changes the status of the node depending on the prior status. In the preferred implementation, the process is embodied in a software program running on a computer system, and operator input occurs by placing a mouse cursor over a graphic illustration of the selection status of the node and clicking, the mouse button. The click event is captured by the system and directed to the process as an “operator input”. This is an example of a type of input to the process, and does not necessarily limit the input to this mode of operation.

Eight different status states are possible depending on the prior status of the node and its children, if any. These different options are illustrated in FIG. 4A. If the node was not selected (status=1), then the process sets the node status to selected (status=2). If the node was not selected, but child nodes were selected (status=3), the process changes the status to selected (status=2). If the node was selected but child elements were excluded (status=4), the process changes the status to not selected (status=1). If the node was specifically excluded from a selected parent node (status=5), the process sets the status to included (status=6), i.e. it is included in the selection of the parent node. If the status is included (status=6) then the process sets the status to excluded (status=5), i.e. it is now specifically excluded from the selection of the parent node. If the status is blocked (status=7). this means that the node is a child of a parent node specifically excluded from a selection of its parent, so an attempt to change this status is ignored; it must be altered at the parent node level. If the status is included with exclusions (status=8) then the process sets the status to included (status=6). i.e. it is now specifically included as a part of the selection of its parent.

Once the node status is determined, the process communicates the new status to a data repository for the node so it can update the status. In a preferred implementation, the process also updates the icon picture corresponding to the new node status.

The process then accesses the First Child ID attribute to determine whether the node has child nodes. If it does, the process must now “walk down the tree” to determine the effect of the change in status of this node on each of its children. This is a recursive process discussed in the immediately following section. Once this process is completed, the process accesses the node to determine its Parent Id. attribute. If this entry is not null, i.e. the node is not the root node, then the process must now “walk up the tree” to determine the effect of the change in status of this node on its parent. This is process is discussed below in section “e” entitled “Parent Node Process”.

### d. Child Node Process

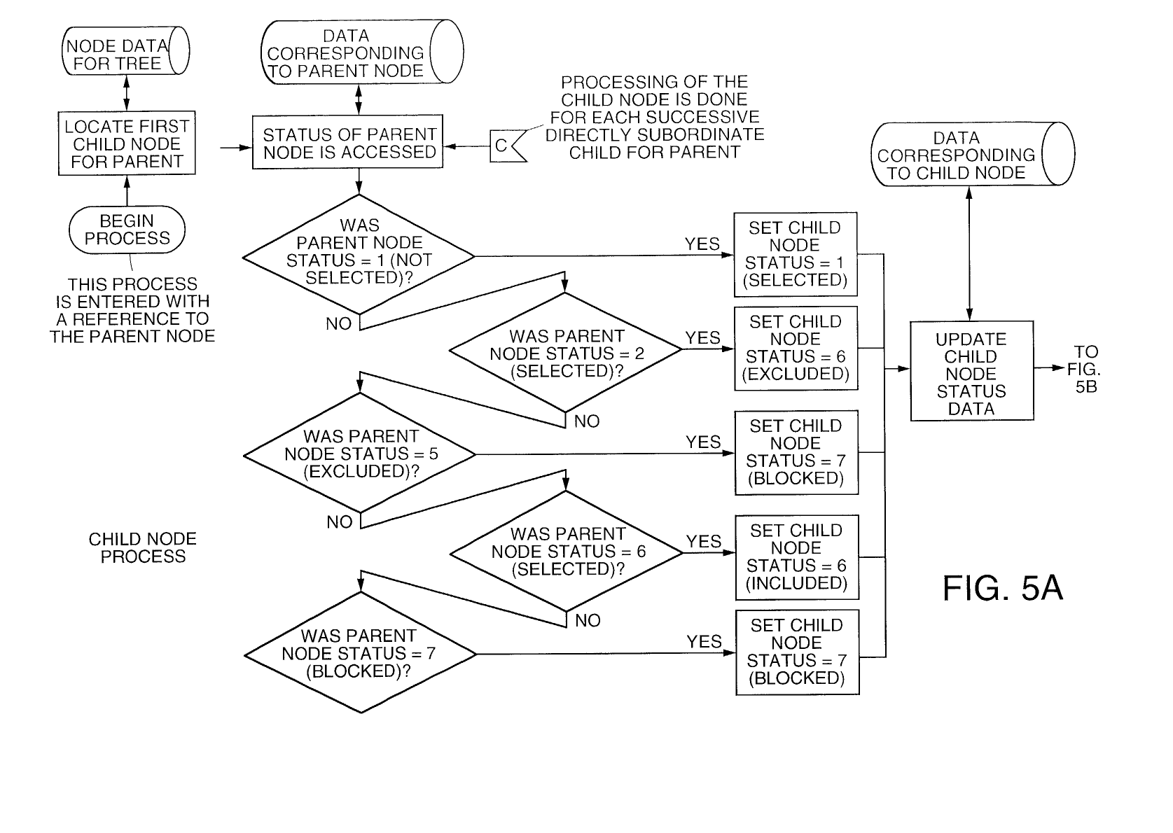

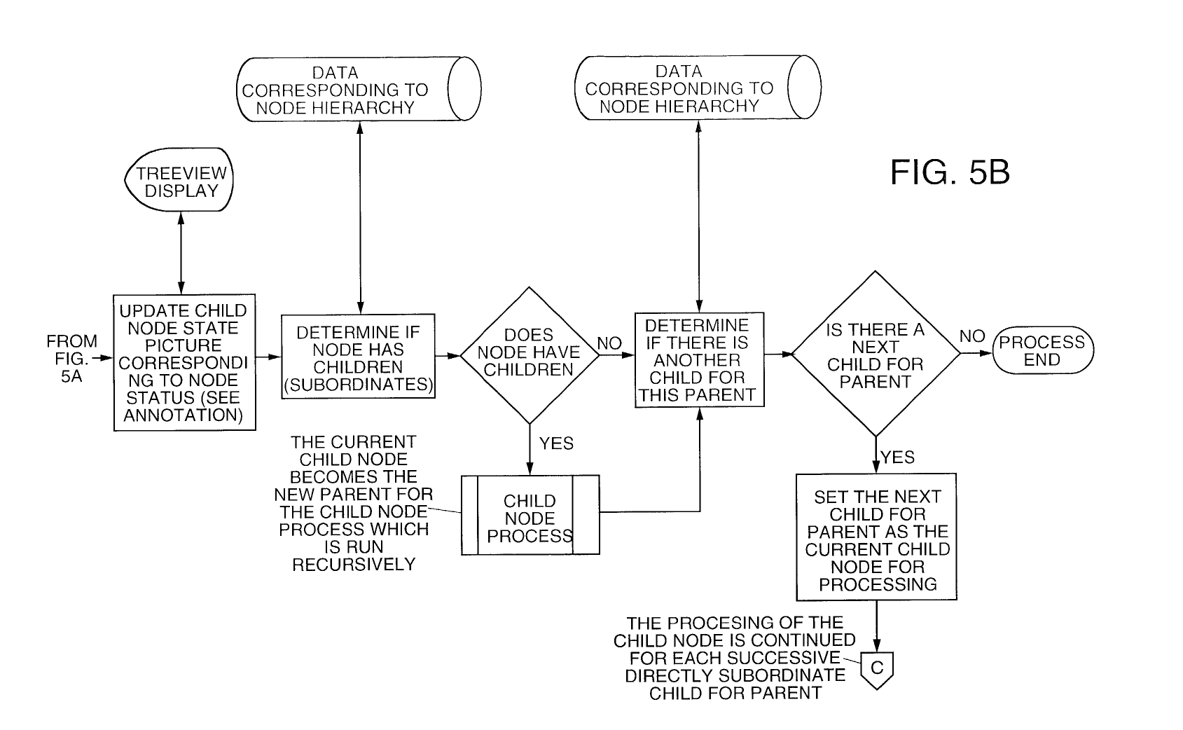

FIGS. 5A and 5B, entitled “Child Node Process”, illustrate the process utilized by the invention to adjust the status of a child node based on a change in status of its parent node. The two pages are best reviewed side-by-side when connected at the “B” connection symbols. The process operates as follows.

This process commences with the action designated in the upper left hand corner of FIG. 5A. The process is called from the process for the parent node discussed in the prior section. The first step is to locate the first unprocessed child of the parent node and determine its status as determined in the prior process.

The next step is to determine how changing the parent status effects the child status. These different options are illustrated in FIG. 5A. If the parent node was not selected (status=1), then the process sets the child node status to not selected (status=1). If the parent node was selected (status=2), the process changes the child node status to included (status=6) because the child node was included in the selection of the parent. If the parent node was excluded (status=5), the process changes the child node status to blocked (status=7) meaning that it cannot be selected. If the parent node was included in a larger set (status=6), the process also sets the child node status to included (status=6), i.e. the child is included in the set its parent is included in. If the parent node is blocked (status=7) then the process sets the child node status to blocked as well (status=7).

Once the new child node status is determined, the process communicates the new status to the data repository for the child node so it can update the status. In the preferred implementation, the process also updates the icon picture for the child node corresponding to the new node status.

The process then accesses the First Child ID attribute of the child node to determine whether it has its own child nodes. If it does, the process must now “walk down the tree” to determine the effect of the change in status of this node on each of its children. It does this by recursively reentering the Child Node Process from the beginning and processing the “grand child” node using the “child” node as the new “parent”. If the child node does not have children, the process reenters the Child Node Process at entry point “C” in the diagram and continues processing, all its “siblings” (i.e. the other children of the original parent node) to determine their new status. The process utilizes the Sibling Order Sequence to process each sibling in sequence. When all children, and all children of children, are processed, this process returns to the original process described in the preceding section.

### e. Parent Node Process

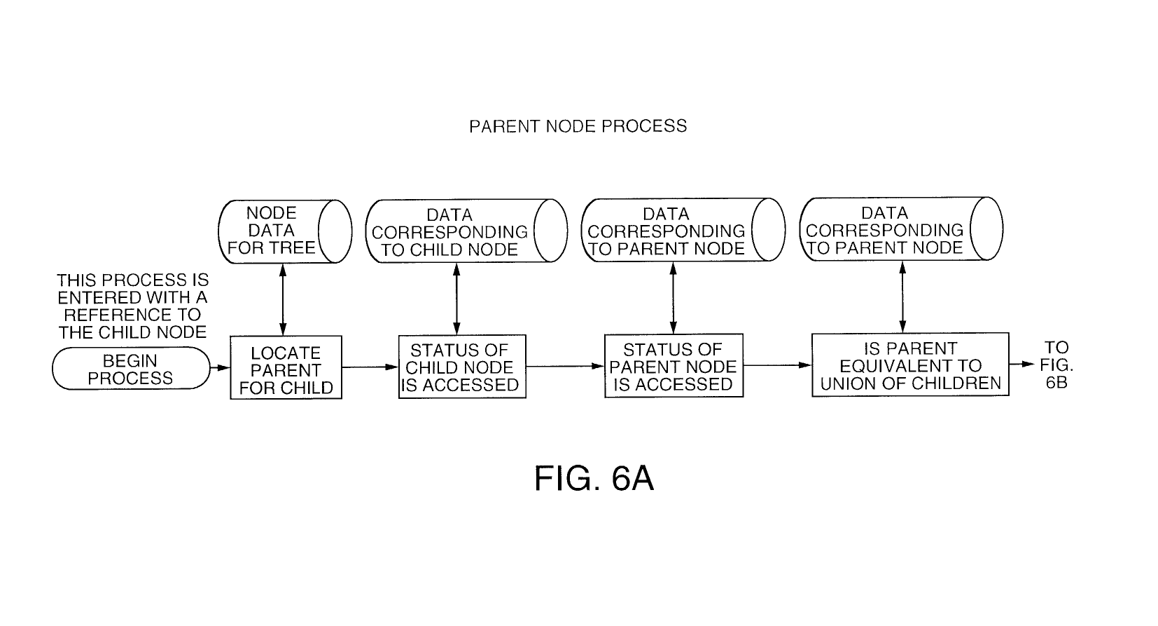

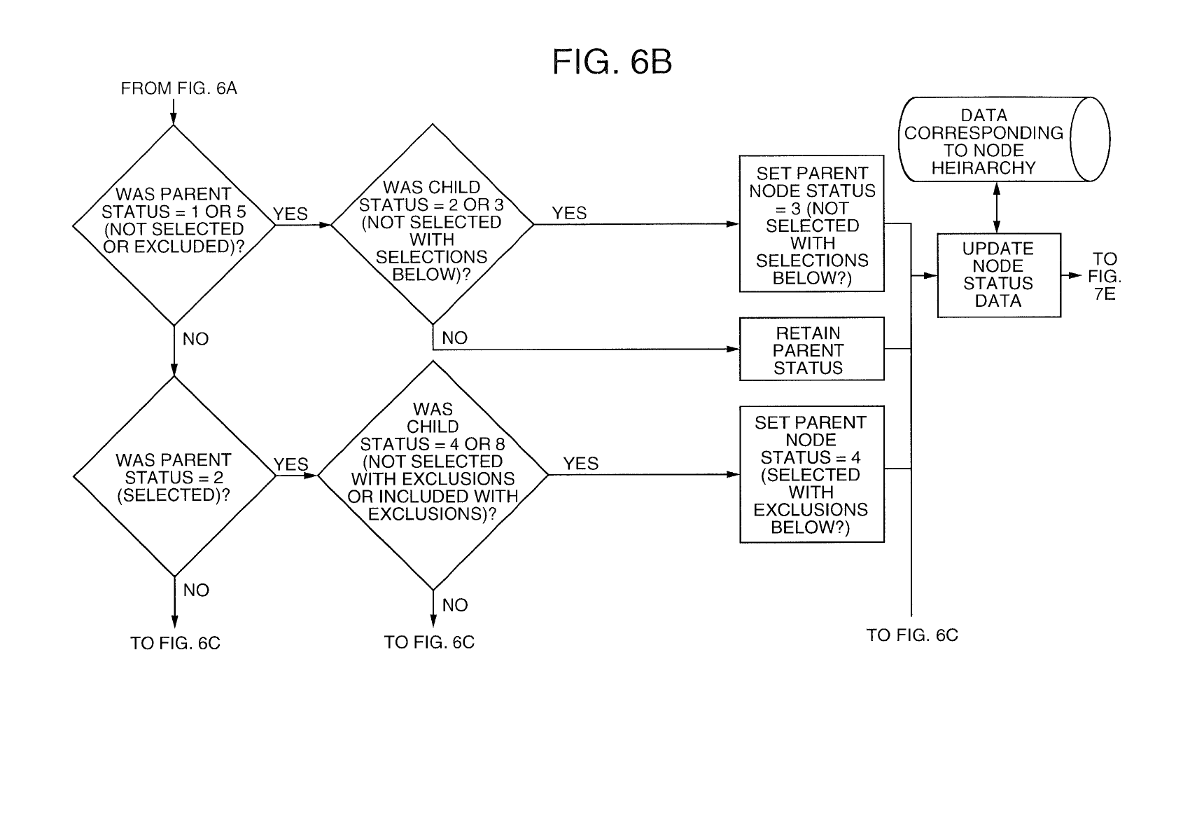

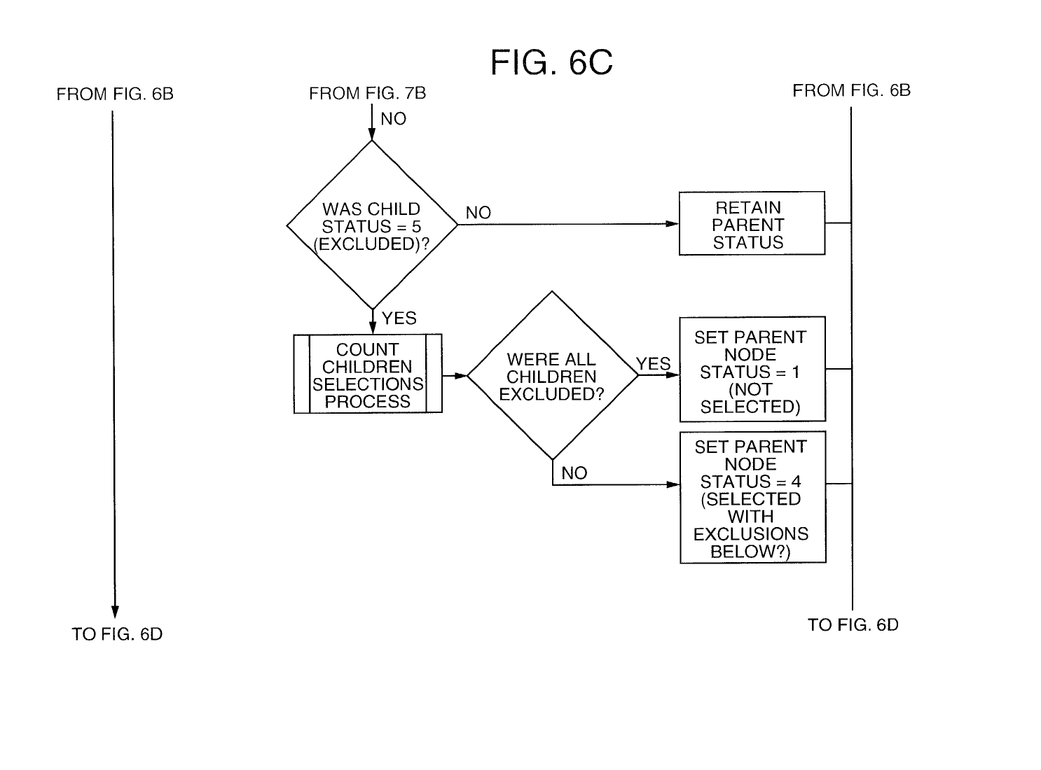

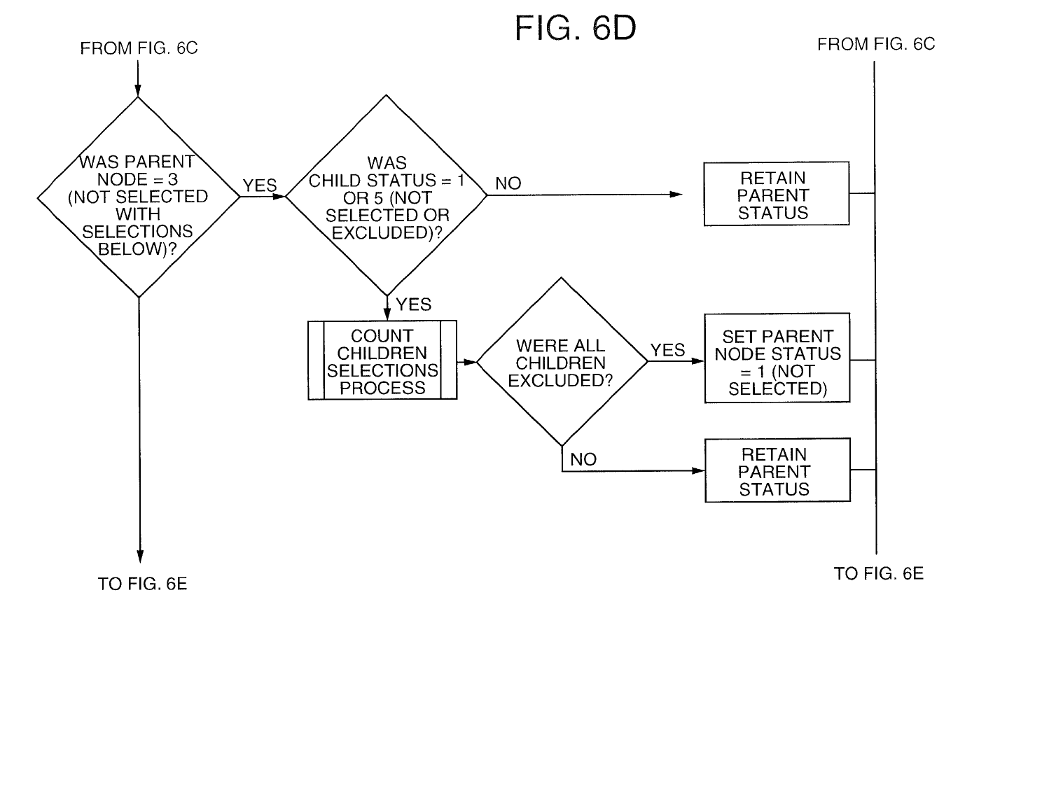

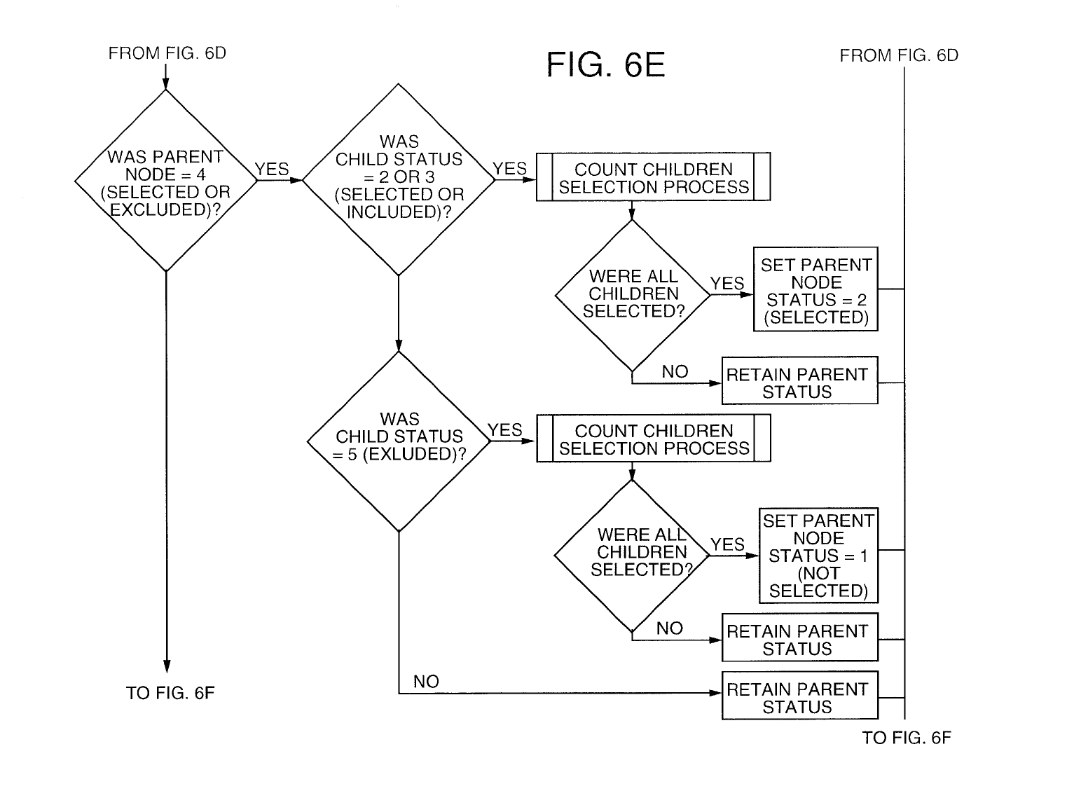

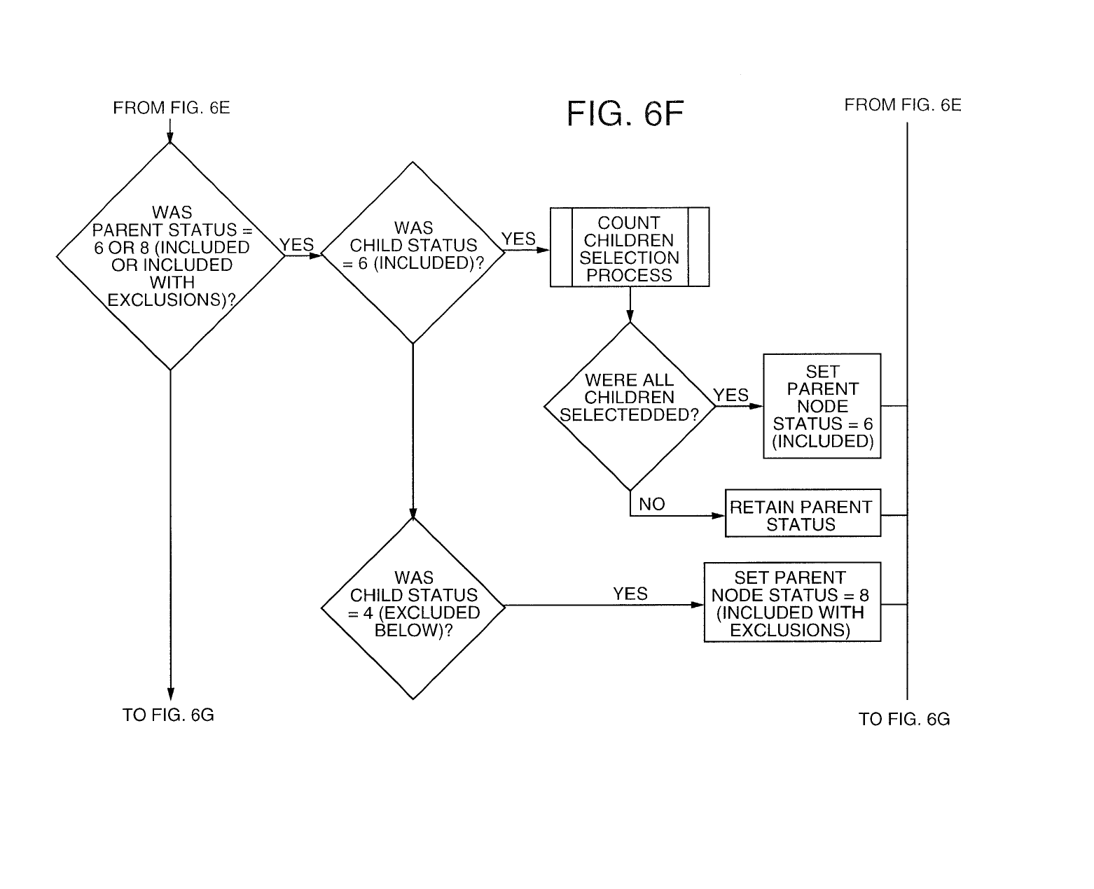

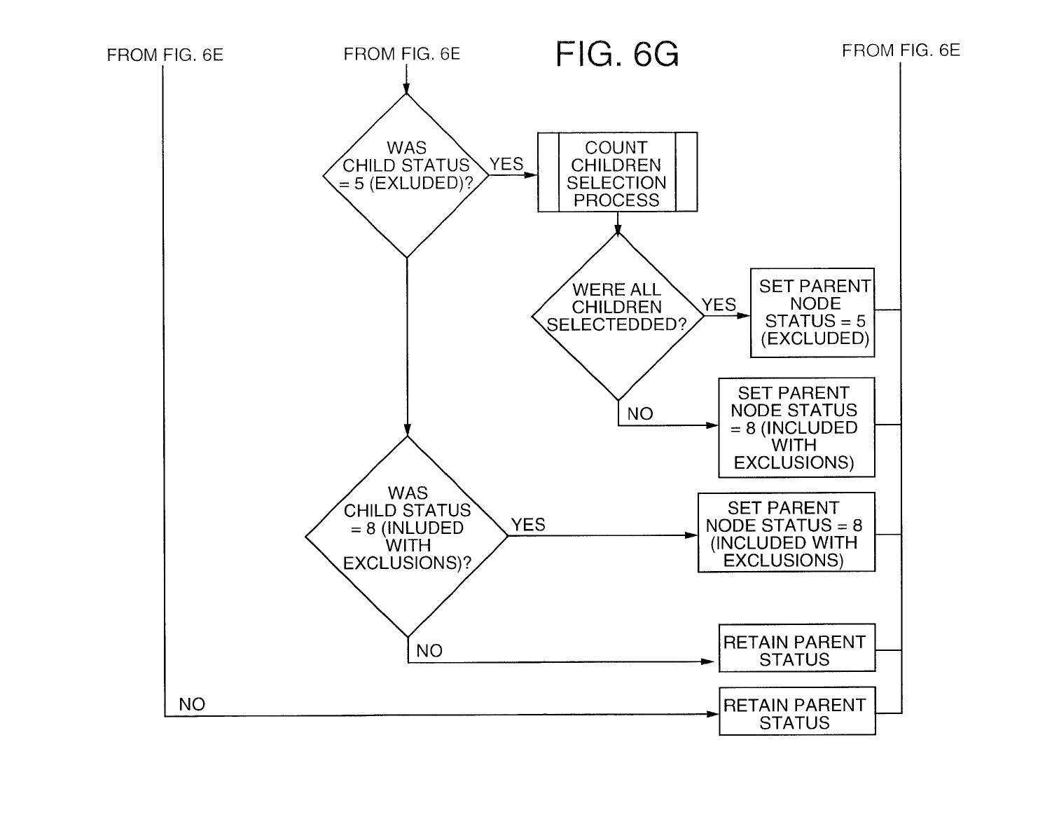

FIGS. 6A-6E, entitled “Parent Node Process”, illustrate the process utilized by the invention to adjust the status of a parent node based on a change in state of a node. FIGS. 6A-6E are best reviewed by assembling the diagram using the connection symbols, “D”, “E”, “F”, “G” “H” and “I”. The process operates as follows.

This process commences with the action designated in the upper left hand corner of FIG. 6A. The process is called from the selection process for the node as discussed in section c above. The first step is to access the Parent ID of the node being selected to determine if it is not null. If it is not, then select and store the status of the child node and the parent node.

The next step is to determine whether the child nodes constitute a full partition of the set designated by the parent node, i.e., does the union of all child nodes equal the parent node. While this may be the case, the invention does not require it. This allows processing of partial sets, and also allows the tree-view to evolve over time as new information is added. Whether the child nodes fully cover the parent node is stored in the IsFullyPartitioned attribute of the parent node.

The next step is to determine how changing the child status effects the parent status. These different options are illustrated in FIGS. 6B, 6C and 6D. Changing a node's parent node can also effect other nodes, so the process is more complicated.

If the parent node was not selected (status=1) or excluded (status=5), then determine whether the child node was selected (status=2) or not itself selected but its children were “selected below” (status=3). If yes, set the parent node status to not selected with selections below (status=3); if no, retain the current parent status.

If the parent node was selected (status=2), then determine whether the child node was selected with inclusions (status=4) or included with exclusions (status=5). If yes, set the parent node status to selected with exclusions below (status=5). If no determine whether the child was excluded (status=5). If no, retain the parent status it is: yes, invoke the Count Children Selection Process (described below) to count all child nodes. As discussed below, the Count Children Selection Process returns an indication of whether all child nodes are selected or excluded when a selection of all child nodes is equivalent to a selection of the parent (i.e. the child sets fully partition the parent set). If so, and if all child nodes were excluded, then set the parent node status to not selected (status=1). If so, but only some child nodes were excluded, then set the parent node status to selected with exclusions below (status=4).

If the parent node was not itself selected but contained selections on included nodes (status=3), then determine whether the child node was not selected (status=1) selected (status=2) or excluded (status=5). If no, retain the parent status; if yes, invoke the Count Children Selection Process (described below) to count all child nodes. If the child nodes fully partition the parent node, and if all child nodes were excluded, then set the parent node status to not selected (status=1). If the child nodes fully partition the parent node, and if only some child nodes were excluded, then retain the parent status.

If the parent node was not itself selected but included in a selection of its parent (status=6) or included with exclusions (status=8), then determine the child node status. If the child node was included (status=6), then invoke the Count Children Selection Process to count all child nodes. If the child nodes fully partition the parent node, and if all child nodes were included, then set the parent node status to included (status=6); if no, retain the parent status. If the child nodes fully partition the parent node, and if the child node was selected with exclusions below (status=4) then set the parent node status to included with exclusions (status=8). If the child node was excluded (status=5), then invoke the Count Children Selection Process to count all child nodes. If all child nodes were excluded, then set the parent node status to excluded (status=5); if no, set the parent node status to included with exclusions (status=8). If the child node was selected with exclusions below (status=8) then set the parent node status to included with exclusions (status=8) otherwise retain the parent status. If none of these selections apply, the parent status is retained.

Once the parent node status is determined, the process communicates the nest status to the data repository for the node so it can update the status. In the preferred implementation, the process will also update the icon picture corresponding, to the new parent node status.

The final step is to determine whether this parent node itself has a parent node. If so, recursively reenter the Parent Node Process to process the status of the parent node.

### f. Count Children Selection Process

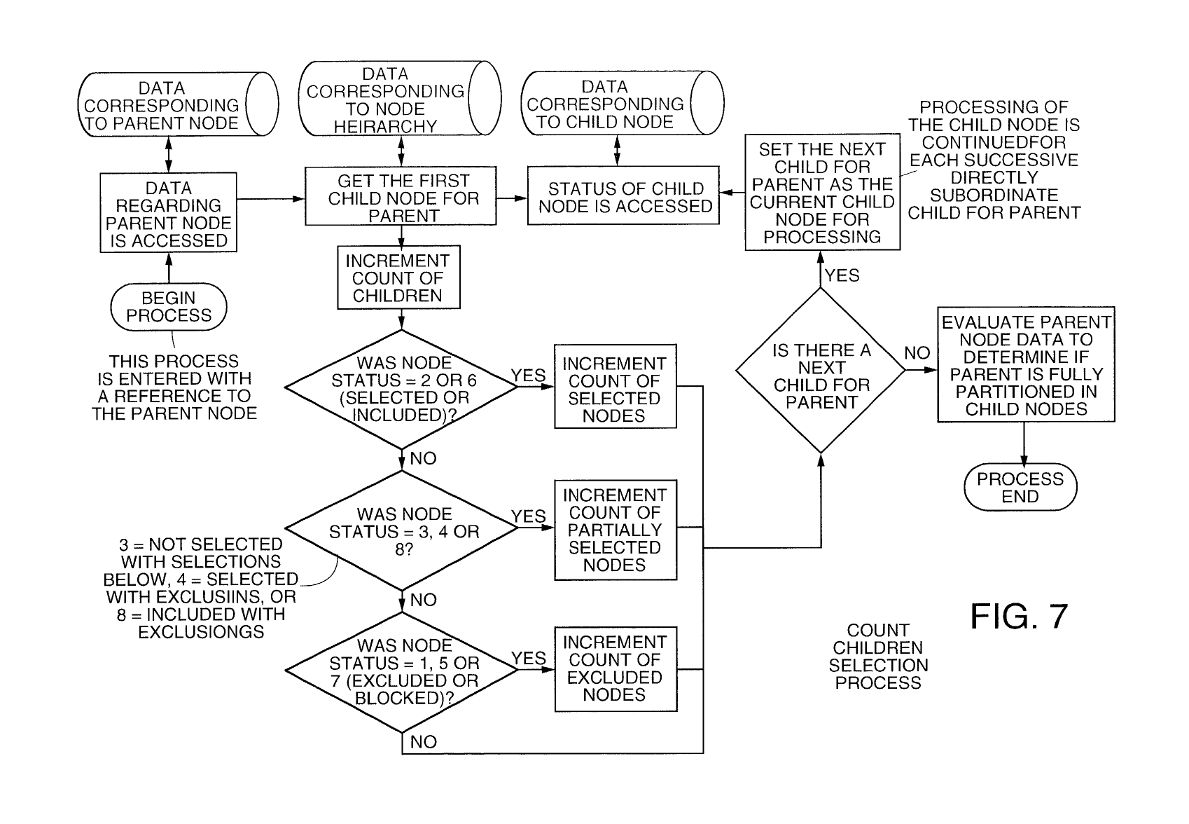

FIG. 7, entitled “Count Children Selection Process”, illustrates the process utilized by the invention to count the number of children of a node. The process operates as follows.

The process begins by accessing the referencing information from the parent that called the process. The process then accesses the status of the current child node.

The process keeps track of all child nodes by maintaining a counter of the current count of child nodes. The first step is to increment the count to keep track of the number of child nodes.

The next step is to evaluate the status of the current child node to determine its status. The process keeps track of child nodes in different states. If the child node was selected (status=2) or included (status=6), then increment the counter for selected nodes. If the child node was not selected with selections below (status=3), selected with exclusions (status=4) or included with exclusions below (status=8), then increment the counter for partially selected nodes. If the child node was not selected (status=1), excluded (status=5) or blocked (status=7), then increment the counter for excluded nodes.

The Count Children Selection process returns information as to whether all child nodes have been selected, all child nodes have been excluded, or a partial selection exists. This result is then evaluated against the condition whether the child nodes fully partition the parent node. i.e., is the set represented by the parent node comprised by a union of all the sets represented by its child nodes. If not, then a result that all child nodes have been selected nonetheless returns a partial selection.

### g. Advantages of Invention

The present invention provides for a marked advantage over existing methods of accessing and storing the results of the selection of individual objects from a complex set. In current implementations of the present invention, selecting objects represented in a tree-view requires “walking down the tree” to each leaf node to determine whether object represented is itself individually selected. For a large tree, with many nodes, the processing involved in “walking the tree” can be significant. [E.g. Shinhal, chapter 11.] Moreover, the cost of storing the status of the individual selections for each node selected in a large set can also be a significant.

Using the invention, however, it is not necessary to “walk down the tree” to each leaf node. Instead, starting at the root node, one need only “walk down the tree” far enough to determine whether a node is fully selected or excluded. If either case occurs, it is not necessary to walk further down that branch of the tree, since in this case the selection status of all child nodes are determined by the status of their parent node. If a node is partially selected, however, only then is it necessary to walk down the tree to the next level to examine the status of selection of each immediate child node. This means that one can store a representation of the selection of objects within a complex set by storing only the status of the nodes that are fully selected, selected with exclusions, or exclusions. It is not necessary to store the status of nodes included within other selections. This invention thus allows for more efficient selection of and storage of information about objects selected in complex sets.

### Illustrative Use of the Invention in a Preferred Embodiment

The following is a concrete illustration of use of the invention in a preferred embodiment to solve a particular problem, in this case selecting sets representing territories covered in a copyright license. It demonstrates the problem of selecting complex sets of included and excluded interests and how the process claimed in the invention, when represented in a preferred embodiment, addresses the problems. The invention is not limited to this use and this example is not intended to limit its field of application. Rather, the illustration is provided to give a concrete example of the use of the invention to address a difficult business problem.

### a. Scope of the Problem

Intellectual property licensing requires the identification and tracking of legal “rights” as identified in the license contract. These licenses are typically “exclusive”. meaning that once the rights are granted, no other party, not even the licensor, call exercise the rights within the “scope” of the license. It is therefore important to ensure that the scope of different licenses do not overlap. As a licensor makes more and more licenses, tracking what has been licensed when and where becomes a complex task.

Establishing the scope of a motion picture license requires identifying at a minimum the geographic area of the license (the “Territory”). The industry currently recognizes approximately 75 different geographic licensing “Territories”. These are often individual countries that are organized hierarchically into larger units or “Regions”. Regions can be geographic, e.g. “North America” (the United States and Canada), or language based, e.g. “English Speaking Europe” (the United Kingdom. Eric and Malta). These territories can be expressed in a hierarchical tree-view, and it would be useful to have a method to select various combinations of territories for licensing at the Region as well as the Territory level, or at finer subdivisions of SubTerritories, such as individual provinces or cities.

Consider, for example, a license for “all Television Rights throughout Western Europe except Italy”. This set description using general categories with simple exclusions (“Western Europe except Italy”) is easily understood. The language can also be entered easily into a license contract. A selection protocol that allowed entry of the main branch (“Western Europe”), and direct exclusion of the omitted item (Italy) would simplify entry and allow representation of the data in contract language.

How the present invention addresses these problems will now be discussed.

### b. Review of Icons

Before discussing the example, a brief review of the use of the icon symbols is provided with reference to FIG. 3. A column is included in FIG. 3 that is marked “status”. This is a code to identify the status of an icon as described in the prior description. The codes used as a convenient reference to a particular status, but is not necessary for implementation of the invention.

In a preferred embodiment the icon symbols are used to convey to the user of the invention the state of a node in a visually meaningful way.

### c. Selection Example

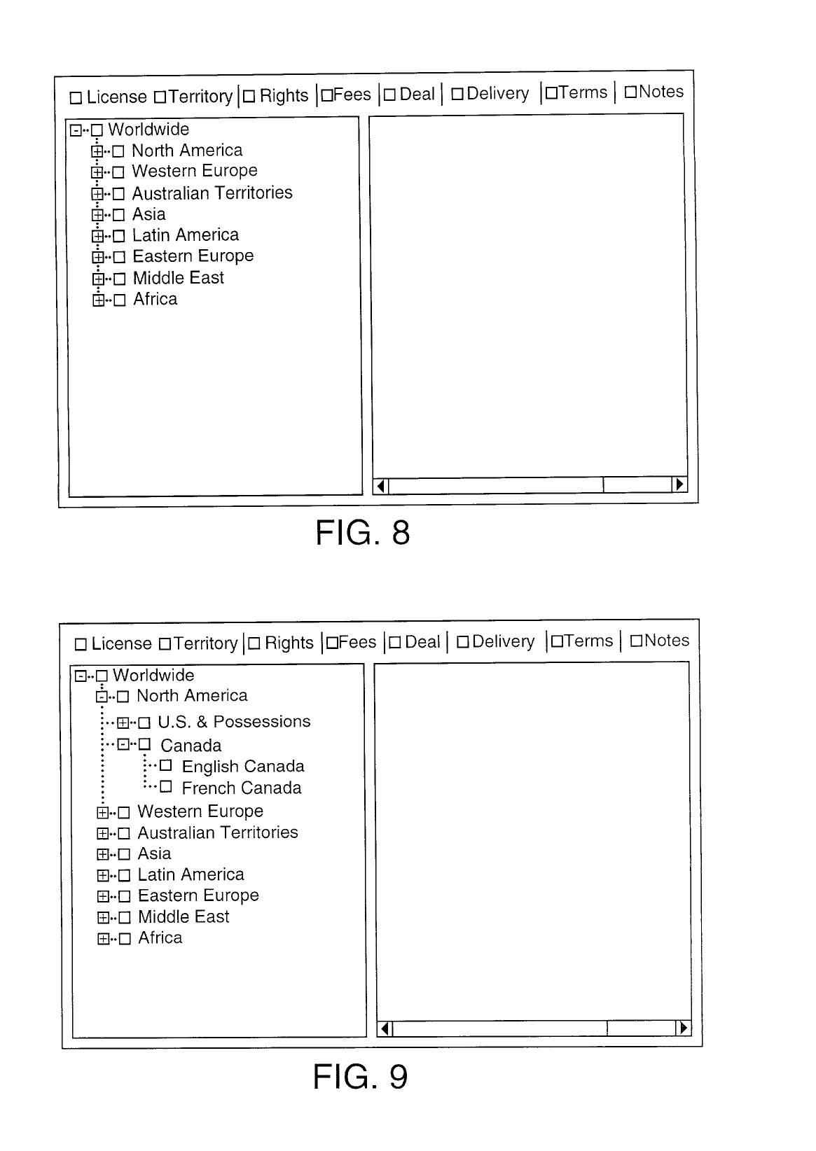

FIG. 8 illustrates an exemplary “Territory Tree” displayed using the present invention. More particularly, shows a display screen derived from a software program in accordance with the present invention that uses a tree-view to represent a collection of data. In the example of intellectual property licensing, it represents a “Territory Tree”.

This Territory Tree displays information for geographic areas on the World. In this embodiment, the Node Type designates that the node represents sets of geographic data. The Node Reference references the specific data set represented by the node. For example, the root node is “World Wide”, which would reference a data set containing all the countries of the world.

FIG. 9 illustrates an exemplary “Expanded Territory Tree” displayed using the present invention. Specifically, FIG. 9 shows the Territory Tree shown in FIG. 8 expanded to four levels of nodes. In this embodiment, nodes on the tree-view are associated with the following values:

WORLD WIDE: This is the root node. It includes all the Territories in Tree View.

REGIONS: The next child nodes are Regions: North America: Western Europe; Australian Territories; Asia: Latin America; Eastern Europe; and Africa.

TERRITORY: Each Region has Territory child nodes. For example, in the North American Region the Territories are US & Possessions and Canada.

SUBTERRITORY: A Territory node may also have child SubTerritories. For example, the Territory US & Possessions contains the United States, Puerto Rico and US Territories.

Interpreting nodes as geographic areas which partition the World is one interpretation of data represented in a hierarchical tree view. It is provided for illustration of use of the invention not as a limitation on other interpretations that might be employed.

FIG. 9, each node of the Territory Tree is proceeded by one or two boxes: an Expansion Box and a Status Box. These work as follows:

EXPANSION BOX: This box allows expansion or contraction of nodes in the Territory Tree. A plus symbol, “+”, means that child nodes exist but are not displayed. A minus symbol, “−”, means that all immediate child nodes are expanded. This is a common use in tree views, and no rights are claimed in this use.

STATUS BOX: This box is added to the Territory Tree to illustrate the status of the node as determined by use of the invention. This adopts one of the eight icons discussed above in order to display the status of selection or exclusion of the node as a result of using the invention. This is part of the claimed invention.

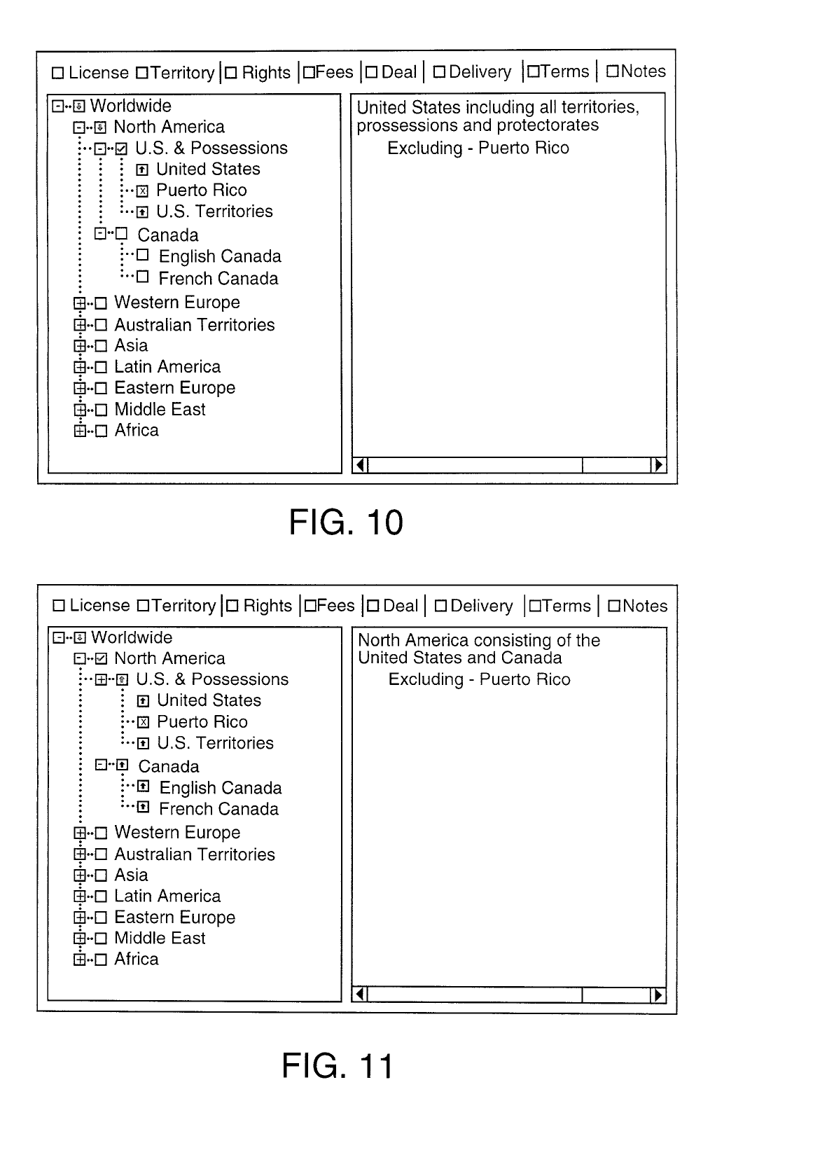

FIG. 10 illustrates an exemplary “Sample Selection” displayed using the present invention. FIG. 10 shows an example in which the user has made a selection. This embodiment utilizes the invented process to render the following display using the identifying icons:

In this particular embodiment, the interpretation of the meaning of this selection is rendered in text in the text box to the right of the Territory Tree. Utilizing the icons, we can interpret the meaning of the selected set identified in words in the text box.

The user utilized the software to select the “U.S. & Possessions” Region, and then specifically excluded “Puerto Rico” from the selection. The invention processes each selection using the procedures described above. The result of the process is illustrated in the various icons. The status box of the World Wide node is designated by a Grey Down Arrow, meaning that this node was not been specifically selected, but some, but not all, child nodes were specifically selected. The status box for the North America node is designated by a Grey Down Arrow for the same reason. The status box for the US & Possessions node has a Grey Check Box, meaning “partially selected”. That is, this node was specifically selected, but some of its child nodes were then specifically excluded. The status box for United States has a Black Up Arrow, meaning that the process determined that this node was not itself selected, but that at parent node was selected. Finally, the status box for the Puerto Rico node shows a Black X, indicating that this node was specifically excluded from the selection of the set of territories designated by the U.S. & Possessions node.

Current tree views embodied in computer software often use only an expansion box. Some use a selection box, but only to indicate a particular item is selected or unselected. Current systems do not use an icon system like the invention to demonstrate how an item is selected in a tree view. They do not demonstrate which nodes are specifically selected in a manner that preserves the order or selection. The invention allows this process and facilitates a graphical representation of the results.

### d. Further Selection Examples

The following examples illustrate two comparable selections made in different ways. They demonstrate how the invention allows preserving the manner of selection as well as what was selected. FIG. 11 illustrates an exemplary “Selection with Exclusions” displayed using the present invention.

Walking the tree shown in FIG. 11, the invented process has determined the status of the following nodes and indicated an iconic representation of the status as follows:

The WorldWide node has an Expansion Box with a “−” indicating the Tree is fully expanded. The gray downward arrow in the Status Box indicates that some child nodes are selected below.

The North America node has an Expansion Box with a “−” indicating that the Tree is fully expanded. The Status Box displays a gray checkmark and indicates that the North America node was selected, but the selection is only partial because there are exclusions on some child nodes.

The node for U.S. & Possessions has a “−” in the Expansion Box since the tree is expanded. The Status Box has a gray up arrow, indicating “selected above but exclusions below”. That is, U.S. & Possessions is included because it is part a larger set (North America) but the inclusion is partial because of excluded child nodes.

The node for United States has no Expansion Box, since it is a terminal node. The Status Box contains a black up arrow, showing “selected above”. It was not individually selected, but is included as part of a larger set (North America) without exclusion of its child nodes.

The node for Puerto Rico has no Expansion Box, since it is a terminal node. The Selection Box has a black “x”, indicating it was specifically excluded.

The text box describes the entry as “North America including the United States and Canada—excluding Puerto Rico”.

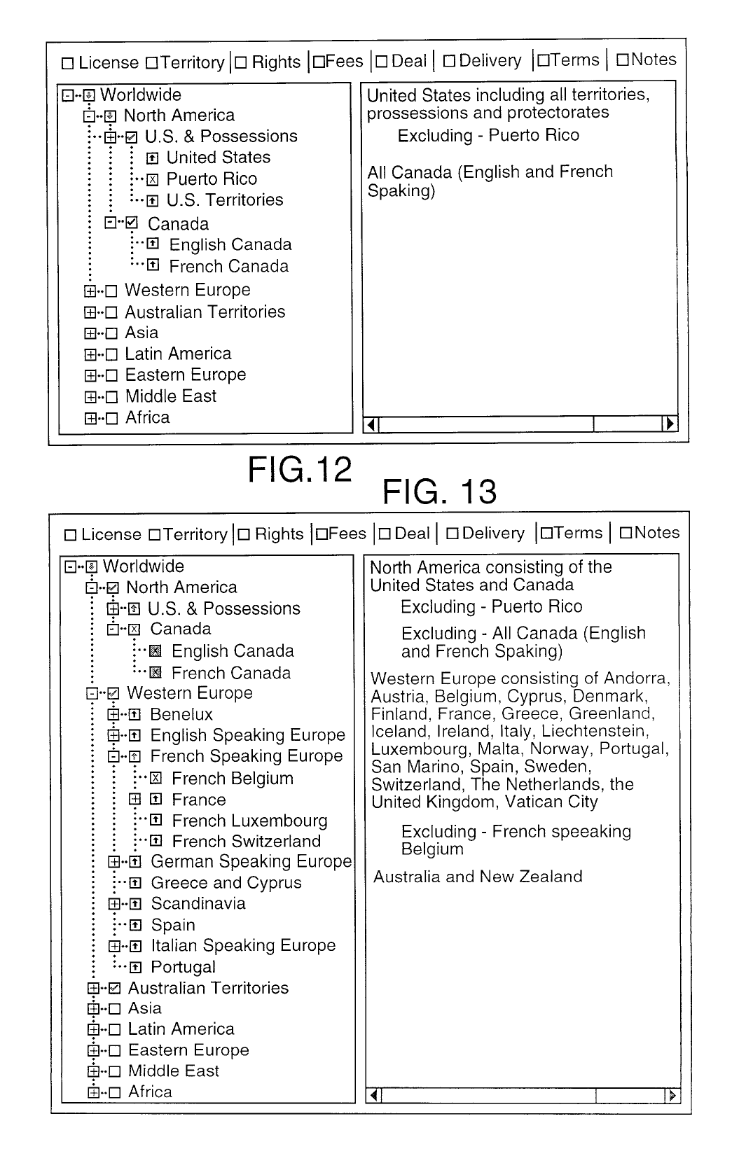

FIG. 12 illustrates an “Alternate Example of Selection with Exclusions” displayed using the present invention. In particular, FIG. 12 shows the same set of elements as those in FIG. 11, only selected in a different manner.

In this case, instead of making the selection at the North America node, the selection was made of its two children nodes, i.e., U.S. & Possessions and Canada. As a result the North America Status Box has changed to a gray down arrow, indicating some but not all of its children are “selected below”. The icon for U.S. & Possessions has changed to a gray check box, indicating selected with exclusions below.

The description of the selection now reads: “United States including all territories, possessions and protectorates—excluding Puerto Rico: All Canada (French and English Speaking). Although this description can be functionally equivalent to the selection in FIG. 11, it is in fact a different selection. This difference in language may make in difference in different cases. It also may provide easier understanding to a user. The invention allows the user to select items in complex combinations of inclusions and exclusions that describe the situation in different ways. Such a selection process that demonstrates the manner of selection is not possible with existing tree views.

The following demonstrates a complex set of inclusions and exclusions for which the process utilizes all of the icons. In particular, FIG. 13 illustrates an exemplary “Complex Set with Inclusions and Exclusions” displayed using the present invention.

The accompanying text box describes the selection. Entering the selection in a database would be tedious. The present invention, in this preferred embodiment, allows a method to create such a complex set with a few clicks of a mouse.

Thus processes that facilitate, through use of software programs, identifying the selection or exclusion and manner of selection or exclusion of complex sets of objects drawn from other sets of such objects have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. Apparatus for selecting or excluding and identifying the manner of selecting and excluding complex sets of objects contained in a set of such objects and for illustrating same in a tree-like graphical form, comprising:
an input data memory for storing a mapping from objects in a set of objects from which a complex set is to be selected to a set of nodes organized in a tree-like structure that represents an ordering of the objects;
an input data memory for storing an identification of each node independent of its order, and for identifying each node in relation to other nodes in the hierarchy by storing references, if any, to a parent node, one or more sibling nodes and one or more child nodes, along with an indication of whether the representation constitutes a full or partial partition of the set that is represented, and for storing a status state of the selection or exclusion of each node to represent the status state of selection or exclusion of the node;
a processing mechanism for changing the status state of nodes in a tree-like graphical presentation of the nodes, storing the results in data memory, and changing the representation of the states based on an input event from the user: and
an output data device that updates the status state of selection of each node effected by the input event by operation of the process and stores the change in data memory.

2. The apparatus recited in claim 1 wherein the processing mechanism comprises a processing system.

3. The apparatus recited in claim 1 wherein the processing mechanism comprises software.

4. The apparatus recited in claim 1 wherein the tree-like structure comprises a hierarchical ordering of the objects.

5. The apparatus recited in claim 4 wherein the input data memory stores an identification of each node that is independent of its position in the hierarchy.

6. The apparatus recited in claim 1 wherein the status state of the selection or exclusion of the node is represented by graphical icons.

7. The apparatus recited in claim 6 wherein the processing system changes the status state of nodes in a tree-like graphical presentation of the nodes, stores the results in data memory, and changes the graphical icon representation of the states based on the input event from the user.

8. The apparatus recited in claim 6 wherein the output data device changes the icon graphically representing the status of selection or exclusion of each node so affected.

9. The apparatus recited in claim 1 wherein the processing system processes the data by:
evaluating a current state of selection or exclusion of a node that is subject to an event, and, based on the state, retaining or changing the state in a designated sequence based upon receipt of the input event;
recursively evaluating the current state of selection or exclusion of each child node, if any, of the node that is subject to the event, and, based on the state of selection, retaining or changing the state in a designated sequence based upon the result of the processing of the node subject to the input event; and
recursively evaluating the current state of selection or exclusion of each parent node, if any, of the node subject to the event, and determining whether all child nodes of the parent constitute a complete partition of the object represented by the parent node, and based on the results, and retaining or changing the status state of the icon in a designated sequence.

10. The apparatus recited in claim 9 wherein the processing system further processes the data by:
updating a display of the state resulting from such processing that corresponds to the node
updating the display of the state resulting from such processing that corresponds to the child node; and
updating the display of the state resulting from such processing that corresponds to the parent node.

11. The apparatus recited in claim 6 wherein the processing system and software processes the data by:
evaluating a current state of selection or exclusion of a node that is subject to an event, and, based on the state, retaining or changing the state in a designated sequence based upon receipt of the input event, and updating a display of the graphical icon representing the state resulting from such processing that corresponds to the node;
recursively evaluating the current state of selection or exclusion of each child node, if any, of the node that is subject to the event, and, based on the state of selection, retaining or changing the state in a designated sequence based upon the result of the processing of the node subject to the input event and updating the display of the graphical icon representing the state resulting from such processing that corresponds to the child node; and
recursively evaluating the current state of selection or exclusion of each parent node, if any, of the node subject to the event, and determining whether all child nodes of the parent constitute a complete partition of the object represented by the parent node, and based on the results, retaining or changing the status state of the icon in a designated sequence and updating the display of the graphical icon representing the state resulting from such processing that corresponds to the parent node.

12. The apparatus recited in claim 11 wherein the processing system further processes the data by:
updating a display of the graphical icon representing the state resulting from such processing that corresponds to the node
updating the display of the graphical icon representing the state resulting from such processing that corresponds to the child node; and
updating the display of the graphical icon representing the state resulting from such processing that corresponds to the parent node.

13. A method for selecting or excluding and identifying the manner of selecting and excluding complex sets of objects contained in a set of such objects, and for illustrating same in a tree-like graphical form, comprising the steps of:
storing a mapping from objects in a set of objects from which a complex set is to be selected to a set of nodes organized in a tree-like structure that represents an ordering of the objects;
storing an identification of each node independent of its position in the order, identifying each node in relation to other nodes in the hierarchy by storing references, if any, to a parent node, one or more sibling nodes and one or more child nodes, along with an indication of whether the representation constitutes a full or partial partition of the set that is represented, and storing a status state of the selection or exclusion of each node;
changing the status state of nodes in a presentation of the nodes, storing the results in data memory, and changing the representation of the states based on an input event from the user; and
updating the status state of selection of each node effected by the input event by operation of the process and storing the change.

14. The method recited in claim 13 wherein the tree-like structure comprises a hierarchical ordering of the objects.

15. The method recited in claim 14 wherein an identification of each node that is independent of its position in the hierarchy is stored.

16. The method recited in claim 13 wherein the status state of the selection or exclusion of the node is represented by graphical icons.

17. The method recited in claim 16 wherein the status state of nodes is stored in a tree-like graphical presentation of the nodes, the results are stored, and the step of updating the status state changes a graphical icon representation of the states based on the input event from the user.

18. The method recited in claim 16 wherein the step of updating the status state changes the icon graphically representing the status of selection or exclusion of each node so affected.

19. The method recited in claim 13 which further comprises the steps of:
evaluating a current state of selection or exclusion of a node that is subject to an event, and, based on the state, retaining or changing the state in a designated sequence based upon receipt of the input event;
recursively evaluating the current state of selection or exclusion of each child node, if any, of the node that is subject to the event, and, based on the state of selection, retaining or changing the state in a designated sequence based upon the result of the processing of the node subject to the input event; and
recursively evaluating the current state of selection or exclusion of each parent node, if any, of the node subject to the event, and determining whether all child nodes of the parent constitute a complete partition of the object represented by the parent node, and based on the results, and retaining or changing the status state of the icon in a designated sequence.

20. The method recited in claim 16 which further comprises the steps of:
evaluating a current state of selection or exclusion of a node that is subject to an event, and, based on the state, retaining or changing the state in a designated sequence based upon receipt of the input event, and updating a display of the graphical icon representing the state resulting from such processing that corresponds to the node;
recursively evaluating the current state of selection or exclusion of each child node, if any, of the node that is subject to the event, and, based on the state of selection, retaining or changing the state in a designated sequence based upon the result of the processing of the node subject to the input event and updating the display of the graphical icon representing the state resulting from such processing that corresponds to the child node; and
recursively evaluating the current state of selection or exclusion of each parent node, if any, of the node subject to the event, and determining whether all child nodes of the parent constitute a complete partition of the object represented by the parent node, and based on the results, retaining or changing the status state of the icon in a designated sequence and updating the display of the graphical icon representing the state resulting from such processing that corresponds to the parent node.
